(19) United States
(12) Patent Application Publication
(10) Pub. No.: US 2014/0150895 A1
(43) Pub. Date: Jun. 5, 2014

(54) Water Conveying Device

(71) Applicants: Eli Zhadanov, Brooklyn, NY (US); Sam Zhadanov, Brooklyn, NY (US)

(72) Inventors: Eli Zhadanov, Brooklyn, NY (US); Sam Zhadanov, Brooklyn, NY (US)

(21) Appl. No.: 13/690,059

(22) Filed: Nov. 30, 2012

(51) Int. Cl. F17D 1/00

(52) U.S. Cl. CPC F17D 1/00
USPC 137/315.01

(57) ABSTRACT

A device for conveying water between first and second water supplying elements has a first hollow water conveying member connectable to the first water supplying element and a second hollow water conveying member connectable to the second water supplying element and with the first water conveying members are turnable relative to one another and about a turning axis, and the first water conveying member has a first opening for water entry and the second water conveying member has a second opening for water exit, and the openings extend transversely to the turning axis and are coaxial with each other.

### BACKGROUND OF THE INVENTION

The present invention relates to water conveying devices for connecting two water supplying members, for example a first hollow water supplying member such as a wall-mounted pipe, with a second hollow water supplying member such as a fixed-mounted showerhead, a hand-held showerhead and the like.

The above mentioned water conveying devices usually include a first water supplying member connectable to a wall-mounted fixed pipe, and a second water supplying member connectable with a showerhead, wherein the first water supplying member has an inlet opening and the second water-supplying member has an outlet opening, and the first and second members are turnable relative to one another, so that the outlet opening of the second water supplying member upon its turning can be located at any desirable location.

Devices for conveying water of the above mentioned general type are known in the art and widely used in shower rooms, bathrooms, etc. In the known water conveying device the first and second members are configured so that axes of the inlet opening and the outlet opening of the first and second water supplying members are offset relative to one another in a direction which is transverse to an axis of turning of the first and second water supplying member relative to one another.

When the device is designed as in the above mentioned prior art, the first and second water supplying members connected by the device are offset sideways from one another, occupy more space, and create imbalance.

### SUMMARY OF THE INVENTION

Accordingly, it is an object of the present invention to provide a device for conveying water from a first water supplying element to a second water supplying element, which avoids the disadvantages of the prior art.

In keeping with these objects and with others which will become apparent hereinafter one feature of the present invention resides, briefly stated, in a device for conveying water from a first water supplying element to a second water supplying element, which includes a first hollow water conveying member connectable to the first water supplying element in water communication therewith; and a second hollow water conveying member connectable to the second water supplying element in water communication therewith and connected with said first water conveying member in water communication therewith, wherein said first and said second water conveying members are turnable relative to one another about a turning axis between a plurality of angular positions relative to one another so that said the first water supplying element and the second water supplying element are locatable in a plurality of positions relative to one another; and wherein said first water conveying member has a first opening for water entry and said second water conveying member has a second opening for water exit, and said first opening and said second opening of said first and second water conveying members extends transversely to said turning axis and are coaxial with each other, so that the first and second water supplying elements connected by the device are coaxial with each other.

When the device for conveying water from a first water supplying elements to a second water supplying element is designed in accordance with the present invention with the first opening of the first water conveying member and the second opening of the second water conveying member being coaxial with one another, the water supplying elements connected by the device are also coaxial and not offset sideways from each other.

In accordance with another feature of the present invention, said first and said second water conveying members are provided with first and second connecting means for connecting said first water conveying member to the first water supplying element and said second water conveying member to the second water supplying element.

In accordance with the invention, said connecting means can include a first connecting structure provided on one of said water conveying members and a second connecting structure provided in the other of said water conveying members and connectable with said first connecting structure.

In accordance with another feature of the invention said first connecting structure is an inner thread, and said second connecting structure is an outer thread, provided correspondingly on said first water conveying member and in said second water conveying member.

A further feature of the present invention resides in that in that one of said water conveying members has a portion with a concave surface, while the other of said water conveying member has a portion with a corresponding convex structure surface, so that when the water conveying member turnabout said pivot axis relative to one another said convex surface moves along said concave surface in correspondence therewith.

Still a further feature of the present invention is that said first water conveying member has a first channel extending from said first opening parallel to and offset from said first axis and a first hole extending from said first channel coaxially with said turning axis, while said second water conveying member has a second channel extending from said second opening parallel to and offset from said second axis and a second hole extending from said second channel coaxially with said turning axis and communicating with said first hole, so that water can flow successively from the first water supplying element through said first opening, said first channel, said first hole of said first water conveying member, and then through said second channel, said second hole and said second opening of said second water conveying member into the second water supplying element.

In accordance with still a further feature of the present invention, the device has means for fixing said water conveying members relative to one another in any of their angular positions relative to on another, and said fixing means include a first fixing element which can be partially insertable into said first hole of said first conveying member and a second fixing element which can be partially insertable into said second hole of said second conveying member and interacting with said first fixing member to immovably connect said first and second water conveying members with another, and while one of said fastening elements can be treated bolt, the other of said fixing elements can be a threaded nut screwable on said threaded bolt.

In accordance with the inventions, sealing means can be provided for water-tight sealing of components of the device relative to one another and including a first tight sealing of components of the device relative to one another and including a first seal provided between said first fixing member and said first water conveying member, a second seal provided between said first fixing member and said first water conveying member, a second seal provided between said first and said second water conveying members, and a third seal provided between said second fixing member and said second fixing member.

Said first seal, said second seal and said third seal extends transversely to the turning axis, are coaxial with in the inventive device, can be arranged coaxially with each other and also coaxial with said turning axis.

The water conveying device in accordance with the present Invention has fixing means which fix the first and second water conveying members with one another and are formed so that the fixing means perform simultaneously multiple functions, including holding the first and second water conveying members with each other, locking the first and second water conveying members in a corresponding angular position relative to one another, and pressing the seals axially to guarantee a leak-free operation.

The novel features of the present invention are set forth in particular in the appended claims. The invention itself however both as to its construction and it manner of operation will be understood from the following description of the preferred embodiments which is accompanied by the following drawings.

### BRIEF DESCRIPTION OF THE DRAWINGS

FIG. 1 is a side view of a first water conveying member of a device for conveying water from a first water supplying element to a second water supplying element in accordance with the present invention;

FIG. 2 is a view showing a cross-section of the first water conveying member which is shown in FIG. 1;

FIG. 3 is a view from above of the first water conveying member which is shown in FIG. 1;

FIG. 4 is a side view of a second water conveying member of the device for conveying water according to the present invention;

FIG. 5 is a view showing a cross-section of the second water conveying member which is shown in FIG. 4;

FIG. 6 is a view from below of the second water conveying member which is shown in FIG. 4;

FIG. 7 is a view showing a cross-section of the inventive device for conveying water in assembled condition;

FIG. 8 is a side view of the inventive device for conveying water in assembled condition;

FIG. 9 is a front view of the inventive device for conveying water in assembled condition; and

FIG. 10 is an exploded view of the device for conveying water in accordance with the present invention.

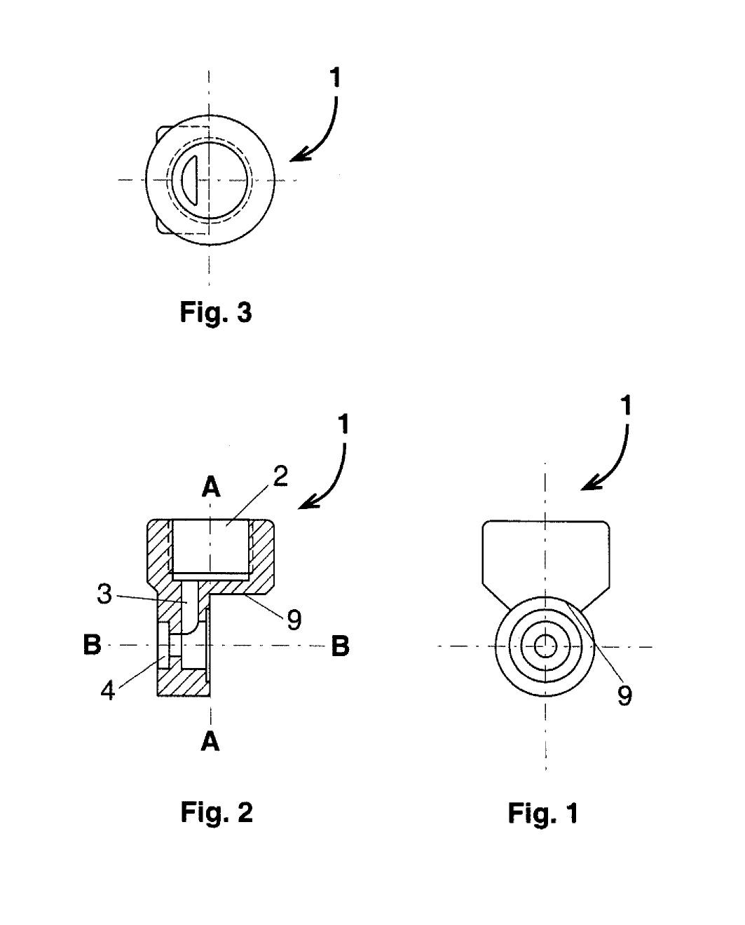

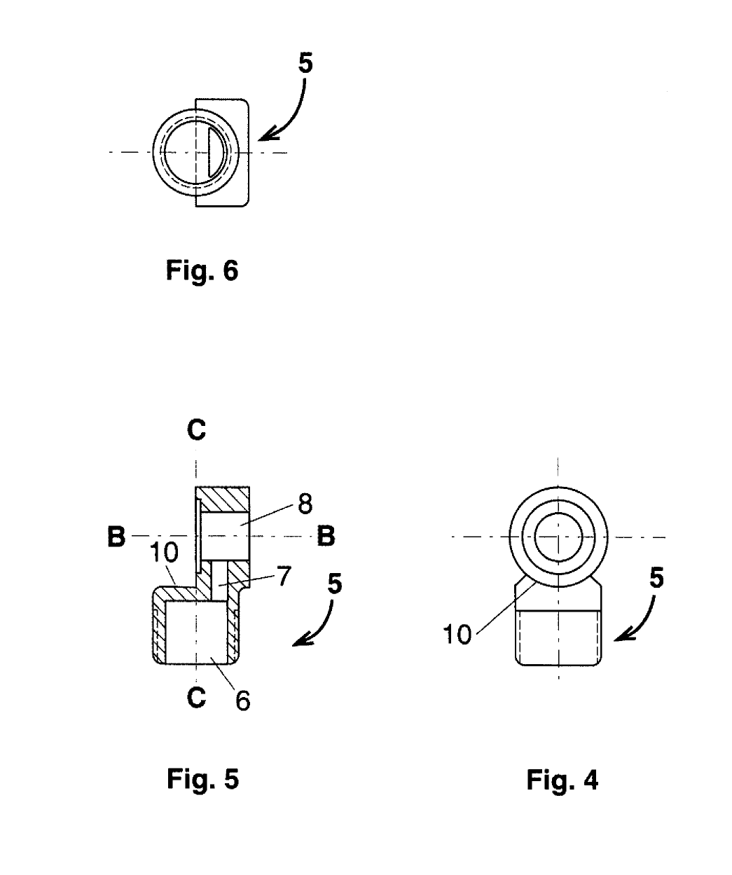

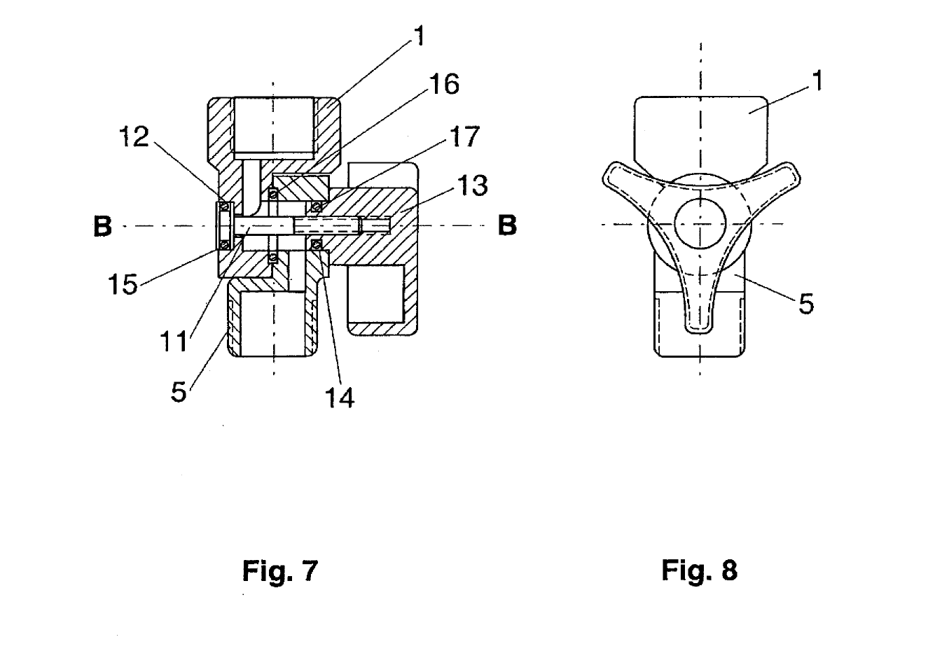

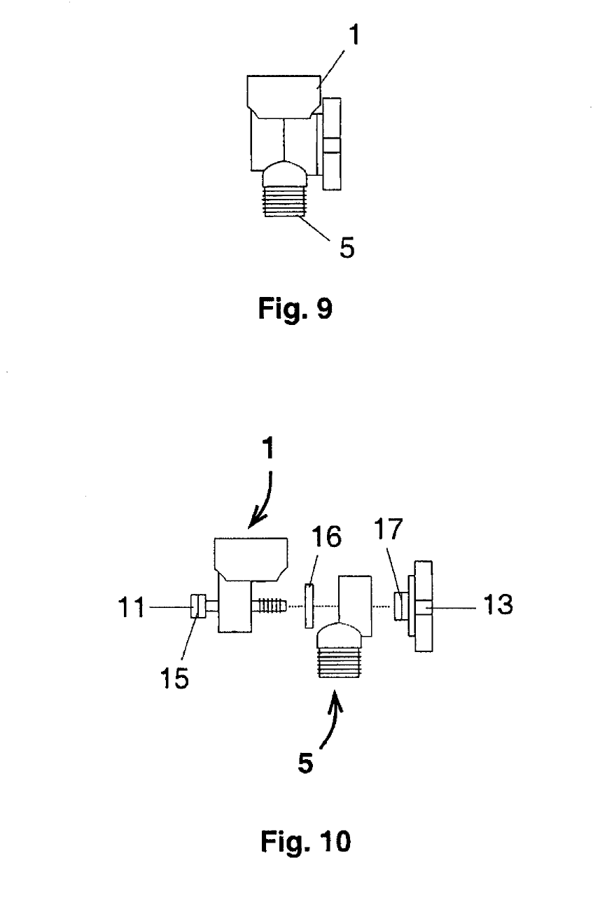

### DESCRIPTION OF THE PREFERRED EMBODIMENTS

A water conveying system in accordance with the present invention has two hollow water conveying members through which water can flow from a first water supplying element, for example a fixedly mounted water supplying pipe, to a second water supplying element, for example a showerhead, and which are turnable relative to one another about a turning axis, for example to change an orientation of the second water supplying member and/or a water flow direction water from the latter.

The first water conveying member is identified with reference numeral 1. It has a first opening 2 forming an inlet and having a first axis A-A, a channel 3 extending from the first opening 2 and having an axis parallel to the axis A-A, and a through hole 4 extending from the channel 3 along a turning axis B-B which is perpendicular to the axis A-A. The opening 2 is used for insertion of a first water supplying element and is provided with first connecting means formed as an inner thread engageable with an outer thread of the first water supplying element when an end part of the latter is inserted into the opening 2.

The second conveying member is identified with reference numeral 5. It has a second opening 6 forming an outlet and having a second axis C-C, a channel 7 extending from the and having an axis parallel to the axis C-C and a through hole 8 extending from the channel 7 along the turning axis B-B. A part of the second water conveying member, in which the second opening 6 is formed, is provided with connecting means formed as an outer thread engageable with an inner thread of the second water supplying element when an end part of the latter is screwed onto the above mentioned threaded part of the second water conveying member.

The first water conveying member 1 has a portion with a concave surface 9, while the second water conveying member 5 has a portion with a convex surface 10 congruent with the concave surface 9, so that when the first and second water conveying member 1 and 5 are assembled with one another and turn relative to one another the surfaces 9 and 10 are slidable over one another, preferably with a sliding contact.

In order to assemble the first and second conveying members with each other, they are first brought into a contact with each other so that axes of their holes 4 and 8 coincide with one another and with the turning axis B-B, and then connecting elements connect them with each other. In this position the axes A-A and C-C of the first and second water conveying members 1 and 5 coincide with one another and form a continuation of each other. The axes B-B of the first and second water conveying members 1 and 5 also coincide with each other. A first connecting element 11 is formed for example as a threaded bolt and inserted into the aligned holes 4 and 8 of the water conveying members so that its head is located in a part 12 of the hole 1, and the second connecting element 13 is formed for example as a nut and is introduced into a part 14 of the hole 8, to be screwed onto a threaded portion of the threaded bolt.

A first seal 15 is provided between the first connecting member or the threaded bolt 11 and the first water conveying member 1, a second seal 16 is provided between the water conveying members 1 and 5, and a third seal 17 is provided between the second connecting member or the nut 13 and the second water conveying members 5. The seals extend transversely to the turning axis B-B and are coaxial with it and with each other.

When for example the second water conveying water member 5 is now turned relative to the first water conveying member 1 to provide a desired angle between them and thereby a desired orientation of the outlet opening 6 relative to the inlet opening 2 and thus a desired orientation of the second water supplying element relative to the first water supplying element, and the nut 13 is tightened on the bolt 11 all seals axially compressed and immovably retained in their respective receiving openings with full water-tightness and the first and second water conveying element are immovably fixed with one another in a selected angular position.

If the user wants to change the angle, it suffices to slightly release (untighten) the nut 13, to rotate the second water conveying member into a desired position, and to tighten the nut 13 again.

The alignment of the axes A-A and C-C of the water conveying members provides for a novel construction of the device, which takes less space in the direction of the turning axis B-B and which prevents a side offset of the water supplying elements and provides their coaxially.

The invention is not limited to the details shown since various modifications are possible without departing from the main spirit of the inventive device.

What is desired to be protected by Letters Patent is set forth in particular in the appended claims:

1. A device for conveying water from a first water supplying element to a second water supplying element, comprising a first hollow water conveying member which is hollow and connectable to the first water supplying element in water communication therewith; and a second hollow water conveying member which is hollow and connectable to the second water supplying element in water communication therewith, wherein said first and said second water conveying members are turnable relative to one another about a turning axis between a plurality of angular positions relative to one another so that said first water supplying element and the second water supplying element are locateable in a plurality of positions relative to one another; and wherein said first water conveying member has a first opening for water entry and said second water conveying member has a second opening for water exit, and said first opening and said second opening of said first and second water conveying members extend transversely to said turning axis and are coaxial with each other so that the water supplying elements connected by the device are also coaxial with each other, wherein said first water conveying member has a first surface extending perpendicular to said turning axis and said second water conveying member has a second surface extending perpendicular to said turning axis; and fixing means which fix said first water conveying member and said second water conveying member with one another, with said first surface of said first water conveying member being in a surface-to-surface contact with said second surface of said second water conveying member, wherein said fixing means include a first fixing element associated with said first water conveying member and a second fixing element interacting with said first fixing element to fix said first and second water conveying members in a desired angular position relative to one another, wherein one of said fixing elements is a threaded bolt while the other of said fixing element is a threaded nut screwable on said threaded bolt; and sealing means which water-tightly seal components of the device relative to one another, wherein said sealing means include a first seal associated with said threaded bolt, a second seal located between said first and second water conveying members, and a third seal associated with said nut, and wherein said first, second, and third seals are coaxial with each other and with said turning axis.

2. A device for conveying water from a first water supplying element to a second water supplying element as defined in claim 1, wherein said first and said second water conveying members are provided with first and second connecting means for connecting said first water conveying members to the first water supplying element and said second water conveying member to the second water supplying element.

3. A device for conveying water from the first water supplying element and the second water supplying element as defined in claim 2, wherein said connecting means include a first connecting structure provided on one of said water conveying members, and a second connecting structure provided in the other of said water conveying members, and wherein said first and second connecting structures are coaxial with said first and second openings of said first and second water conveying members.

4. A device for conveying water from a first water supplying element to the second water supplying element as defined in claim 3, wherein said first connecting structure is an inner thread, and said second connecting structure is an outer thread, provided correspondingly on said first water conveying member and in said second water conveying member.

5. A device for conveying water from a first water supplying element to the second water supplying as defined in claim 1, wherein one of said water conveying members has a portion with a concave surface, while the other of said water conveying members has a portion with a corresponding convex surface, so that when said conveying members turnabout said pivot axis said convex surface moves along said concave surface in correspondence therewith.

6. A device for conveying water from a first water supplying element to a second water supplying element as defined in claim 1, wherein said first water conveying member has a first channel extending from said first opening parallel to and offset from said first axis and a first hole extending from said first channel coaxially with said turning axis, while said second water conveying member has a second channel extending from said second opening parallel to and offset from said second axis and a second hole extending from said second channel and communicating with said first hole, so that water can flow successively from the first water supplying element through said first opening, said first channel, said first hole of said first water conveying member, and then through said second hole, said second channel and said second opening of said second water conveying member into the second water supplying element.

7. A device for conveying water from a first water supplying element to a second water supplying element as defined in claim 6, wherein said first channel and said second channel of said first and second water conveying members extend parallel to one another and in a direction which is perpendicular to said turning axis, and wherein said first hole and said second hole of said first and second water conveying members are coaxial with one another and with said turning axis and form together a joint throughgoing hole for a flow of water.

8. (canceled)

9. (canceled)

10. (canceled)

11. A device for conveying water between a first water supplying element and a second water supplying element as defined in claim 1, wherein said first seal, said second seal and said third seal extend transversely to said turning axis, and are compressed when said fixing elements are connected with one another and said fixing means are tightened and fix said first water conveying member and said second water conveying member in said desired angular position relative to one another.

12. A device for conveying water between a first water supplying element and a second water supplying element as defined in claim 1, wherein said first and said second fixing elements of said fixing means are coaxial with said first seal, said second seal, and said third seal of said sealing means.

13. A device for conveying water between a first water supplying element and a second water supplying element as defined in claim 1, wherein said first and second fixing elements are configured so that they perform multiple functions including holding said first and said second water conveying members together, locking said first and second water conveying members in corresponding angular positions relative to one another, and pressing said seals toward one another and toward components of the device for a leak-free operation.

14. (canceled)

15. A device for conveying water between a first water supplying element and a second water supplying element as defined in claim 1, wherein said first seal is arranged on a head of said threaded bolt inserted in said first water conveying member, surrounds said head of said threaded bolt, and is located radially between said head of said threaded bolt and said first water conveying element.

16. A device for conveying water between a first water supplying element and a second water supplying element as defined in claim 15, wherein said third seal is arranged on a portion of said threaded nut inserted in said second water conveying member, surrounds said portion of said threaded nut and is located radially between said portion of said threaded nut and said second water conveying member.
